(19) United States
(12) Patent Application Publication
(10) Pub. No.: US 2015/0104696 A1
(43) Pub. Date: Apr. 16, 2015

(54) SECONDARY BATTERY AND METHOD OF MANUFACTURING THE SAME

(71) Applicant: SAMSUNG SDI CO., LTD., Yongin-si (KR)

(72) Inventors: Bong-Kyoung Park, Yongin-si (KR); Hye-Jung Lee, Yongin-si (KR); Feygenson Naum, Yongin-si (KR)

(21) Appl. No.: 14/475,358

(22) Filed: Sep. 2, 2014

(30) Foreign Application Priority Data
Oct. 14, 2013 (KR) 10-2013-0122191

(51) Int. Cl. H01M 10/04; H01M 2/02

(52) U.S. Cl. CPC H01M 10/04; H01M 2/02
USPC 429/163; 29/623.5

(57) ABSTRACT

A second battery including: a separator including a surface and an other surface facing away from the surface; a first electrode including a plurality of first electrode wires on the surface of the separator, each first electrode wire being adjacent to an other of the plurality of first electrode wires, and a plurality of first active material layers being on respective outer circumferential surfaces of the plurality of first electrode wires; a second electrode including a plurality of second electrode wires on the other surface of the separator, each second electrode wire being adjacent to an other of the plurality of second electrode wires, and a plurality of second active material layers being on respective outer circumferential surfaces of the plurality of second electrode wires; and a pouch configured to encapsulate the separator, the first electrode, and the second electrode, is disclosed.

### CROSS-REFERENCE TO RELATED APPLICATION

This application claims priority to and the benefit of Korean Patent Application No. 10-2013-0122191, filed on Oct. 14, 2013, in the Korean Intellectual Property Office, the entire content of which is incorporated herein by reference.

### BACKGROUND

1. Field

One or more aspects according to embodiments of the present invention relate to a secondary battery and a method of manufacturing the same.

2. Description of the Related Art

In general, in contrast to a primary battery that is not designed to be charged, discharged and recharged, a secondary battery can be charged, discharged and recharged. Depending on a design of an external device coupled to the secondary battery, the secondary battery may be used in the form of a single battery or in the form of a battery module including a plurality of secondary batteries.

### SUMMARY

One or more aspects according to embodiments of the present invention relate to a flexible secondary battery.

Additional aspects will be set forth in part in the description that follows and, in part, will be apparent from the description, or may be learned by practice of the presented embodiments.

According to one or more embodiments of the present invention, a secondary battery includes a separator including a surface and an other surface facing away from the surface; a first electrode including a plurality of first electrode wires on the surface of the separator, each first electrode wire being adjacent to an other of the plurality of first electrode wires, and a plurality of first active material layers being on respective outer circumferential surfaces of the plurality of first electrode wires; a second electrode including a plurality of second electrode wires on the other surface of the separator, each second electrode wire being adjacent to an other of the plurality of second electrode wires, and a plurality of second active material layers being on respective outer circumferential surfaces of the plurality of second electrode wires; and a pouch configured to encapsulate the separator, the first electrode, and the second electrode.

Each of the plurality of first electrode wires and each of the plurality of second electrode wires may have a round cross-section.

The first electrode and the second electrode may be parallel to one another and separated from each other by the separator.

The first electrode wires may have respective heights from the surface of the separator that are equal to each other.

The second electrode wires may have respective heights from the other surface of the separator that are equal to each other.

The pouch may house an electrolyte, and the first electrode and the second electrode may be coupled to each other through the electrolyte.

The secondary battery may further include a first binder covering the plurality of first active material layers and a portion of the surface of the separator; and a second binder covering the plurality of second active material layers and a portion of the other surface of the separator.

Each of the first binder and the second binder may include polyvinylidene fluoride (PVDF), hexafluoropropylene (HFP), or a mixture or copolymer thereof.

The secondary battery may be flexible.

According to one or more embodiments of the present invention, a secondary battery includes a first electrode including a plurality of first electrode wires in a single row on a surface of a separator and a plurality of first active material layers on respective outer circumferential surfaces of the plurality of first electrode wires; a second electrode including a plurality of second electrode wires in a single row on an other surface of the separator and a plurality of second active material layers on respective outer circumferential surfaces of the plurality of second electrode wires; and a pouch configured to encapsulate the first electrode and the second electrode.

The plurality of first electrode wires may be configured to allow the plurality of first active material layers to contact each other.

The plurality of second electrode wires may be configured to allow the plurality of second active material layers to contact each other.

The plurality of first electrode wires may have respective heights from the surface of the separator that are equal to each other, and the plurality of second electrode wires may have respective heights from the other surface of the separator that are equal to each other.

The secondary battery may further include a first binder covering the plurality of first active material layers and a portion of the surface of the separator; and a second binder covering the plurality of second active material layers and a portion of the other surface of the separator.

Each of the first binder and the second binder may include polyvinylidene fluoride (PVDF), hexafluoropropylene (HFP), or a mixture or copolymer thereof.

Each of the plurality of first electrode wires and each of the plurality of second electrode wires may have a round cross-section.

According to one or more embodiments of the present invention, a method of manufacturing a secondary battery includes: forming a first electrode by arranging a plurality of first electrode wires in a single row on a surface of a separator and forming a plurality of first active material layers on respective outer circumferential surfaces of the plurality of first electrode wires; forming a second electrode by arranging a plurality of second electrode wires in a single row on an other surface of the separator and forming a plurality of second active material layers on respective outer circumferential surfaces of the plurality of second electrode wires; housing the separator, the first electrode and the second electrode in a pouch; and injecting an electrolyte into the pouch.

The forming of the first electrode may further include forming a first binder on the plurality of first active material layers and a portion of the surface of the separator, after arranging the plurality of first electrode wires in the single row on the surface of the separator.

The forming of the second electrode may further include forming a second binder on the plurality of second active material layers and a portion of the other surface of the separator, after arranging the plurality of second electrode wires in the single row on the other surface of the separator.

The plurality of first electrode wires may be arranged to have respective heights from the surface of the separator that are equal to each other, and the plurality of second electrode wires may be arranged to have respective heights from the other surface of the separator that are equal to each other.

### BRIEF DESCRIPTION OF THE DRAWINGS

These and/or other aspects and advantages of the present invention will become apparent and more readily appreciated by reference to the detailed description of the following embodiments when considered together with the accompanying drawings, in which:

FIG. 1 is a cross-sectional view of a secondary battery according to an embodiment of the present invention;

FIG. 2 is a perspective view of the secondary battery shown in FIG. 1;

FIG. 3 is a cross-sectional view of the secondary battery according to the embodiment of the present invention shown in FIGS. 1 and 2; and

FIGS. 4 through 11 are cross-sectional views illustrating a process of a method of manufacturing a secondary battery according to an embodiment of the present invention.

### DETAILED DESCRIPTION

One or more embodiments of the invention allow for various changes or modifications, and only certain embodiments are illustrated in the drawings and described in the detailed description. However, this is not intended to limit the present invention to particular modes of practice, and it will be appreciated that all changes, equivalents, and substitutes that do not depart from the spirit and technical scope of the embodiments of the present invention are encompassed by embodiments of the present invention. In the following description, like reference numerals in the drawings denote like or similar elements throughout the specification.

While such terms as “first,” “second,” etc., may be used to describe various components, such components must not be limited to the above terms. The above terms are used only to distinguish one component from another.

The terms used in the present specification are merely used to describe certain embodiments, and are not intended to limit the present invention. An expression used in the singular encompasses the expression of the plural, unless it has a clearly different meaning in the context. In the context of the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, in the context of the present application, when a first element is referred to as being “on” a second element, it can be directly on the second element or be indirectly on the second element with one or more intervening elements therebetween.

Reference will now be made in detail to certain embodiments of the present invention, examples of which are illustrated in the accompanying drawings. Expressions such as “at least one of,” when preceding a list of elements, modify the entire list of elements and do not modify the individual elements of the list.

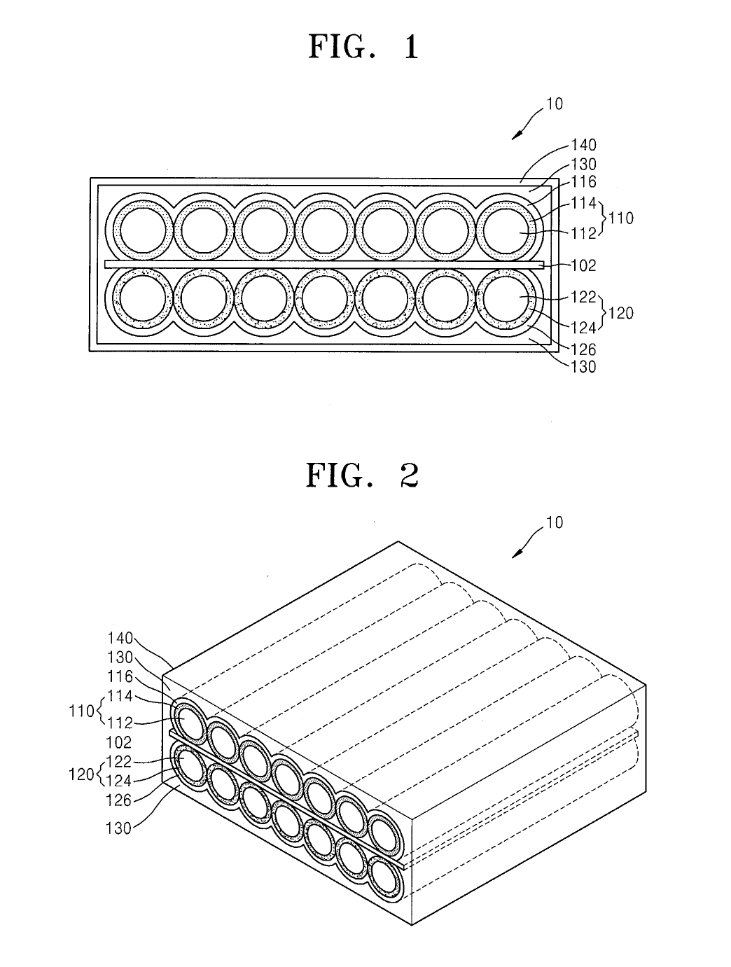

FIG. 1 is a cross-sectional view of a secondary battery 10 according to an embodiment of the present invention. FIG. 2 is a perspective view of the secondary battery 10 shown in FIG. 1.

Referring to FIGS. 1 and 2, the secondary battery 10 may include a first electrode 110, a second electrode 120, and a separator 102 between the first electrode 110 and the second electrode 120.

The first electrode 110 includes a plurality of first electrode wires 112 having first active material layers 114 on (e.g., formed on) their respective outer circumferential surfaces.

Each of the first active material layers 114 may be formed by mixing a solvent, a first active material, a conductive material (e.g., a material for improving conductivity), and a binder (e.g., a binder for improving adhesion of materials) together. For example, the first active material may be a positive active material. The positive active material may include, a lithium-based transition metal oxide such as LiCoO₂, LiNiO₂, LiMnO₂, or LiMnO₄, or a lithium chalcogenide-based compound, but the positive active material is not limited thereto.

Each first active material layer 114 may be formed using a dipping method, a deep coating method, a spray coating method, a spin coating method, a roll coating method, a die coating method, a roll coat method, a gravure printing method, or a bar coat method. However, the method of forming the first active material layers is not limited thereto.

The first electrode wires 112 having the first active material layers 114 formed thereon may be arranged to be parallel to each other in a single row on the separator 102 and the first electrode wires 112 may contact each other.

Each of the first electrode wires 112 may have a round cross-section. However, the first electrode wires are not limited thereto. For example, each first electrode wire 112 may have a cross-section other than a round cross-section.

Each first electrode wire 112 may include (e.g., may be formed of) a material having high conductivity. The material is not limited and may be any suitably conductive material, provided that the material does not cause a chemical change to a component of the secondary battery. For example, each first electrode wire 112 may include (e.g., may be formed of) aluminum, nickel, titanium, baked carbon, or the like, but the material is not limited thereto.

The second electrode 120 includes a plurality of second electrode wires 122 having second active material layers 124 on (e.g., formed on) their respective outer circumferential surfaces.

Each of the second active material layers 124 may be formed by mixing a solvent, a second active material and a binder (e.g., a binder for improving adhesion of the second active material). For example, the second active material may be a negative active material.

The negative active material may include, a carbon material such as crystalline carbon, amorphous carbon, a carbon composite, a carbon fiber, etc., lithium metal, or a lithium alloy, but the negative active material is not limited thereto.

Each second active material layer 124 may be formed using a dipping method, a deep coating method, a spray coating method, a spin coating method, a roll coating method, a die coating method, a roll coat method, a gravure printing method, or a bar coat method. However, the method of forming the second active material layers not limited thereto.

The second electrode wires 122 having the second active material layers 124 formed thereon may be arranged to be parallel to each other, and the second electrode wires 122 may face the first electrode wires 112 with the separator 102 therebetween.

In more detail, the first electrode wires 112 are on a surface of the separator 102, and the second electrode wires 122 are on the other surface of the separator 102, which faces away from the surface of the separator 102.

Each of the second electrode wires 122 may have a round cross-section. However, the second electrode wires are not limited thereto. For example, each second electrode wire 122 may have a cross-section other than a round cross-section.

Each second electrode wire 122 may be formed of a conductive metal material such as copper, stainless steel, aluminum, nickel, or the like, but the second electrode wires are not limited thereto.

In order to interconnect the first electrode wires 112 having the first active material layers 114 formed thereon and to fix the first electrode wires 112 to the separator 102, a first binder 116 is formed on the first electrode wires 112 and a portion of the separator 102.

The first binder 116 may include polyvinylidene fluoride (PVDF), hexafluoropropylene (HFP), or a mixture or copolymer thereof, but the first binder is not limited thereto.

In order to interconnect the second electrode wires 122 having the second active material layers 124 formed thereon and to fix the second electrode wires 122 to the separator 102, a second binder 126 is formed on the second electrode wires 122 and a portion of the separator 102.

The second binder 126 may include PVDF, HFP, or a mixture or copolymer thereof, but the second binder is not limited thereto.

The separator 102 is between the first electrode 110 and the second electrode 120 so that the separator 102 prevents a short-circuit between the first electrode 110 and the second electrode 120 (or reduces a likelihood of such a short-circuit) and allows a transfer of charges (e.g., electric charge).

The separator 102 may be formed by coating a PVDF-HFP co-polymer on a base material including polyethylene (PE), polystyrene (PS), polypropylene, or a co-polymer of PE and polypropylene, but the separator is not limited thereto.

A pouch 140 encapsulates the first electrode 110 and the second electrode 120, and internally houses the first electrode 110 and the second electrode 120 together with an electrolyte 130.

The pouch 140 may have a three-layer structure including, for example, an insulating layer, a metal layer, and an insulating layer, but the pouch is not limited thereto. For example, the metal layer may include (e.g., may be formed of) aluminum, steel, stainless steel, or the like, and the insulating layer may be formed of casted polypropylene (CPP), polyethylene terephthalate (PET), nylon, or the like, but the metal layer and insulating layer are not limited thereto.

The electrolyte 130 may be a liquid electrolyte or a gel electrolyte, and the first electrode 110 and the second electrode 120 may be coupled (or connected) to each other through (e.g., by way of) the electrolyte 130. For example, the electrolyte 130 may electrically connect the first electrode 110 to the second electrode 120. In some embodiments the first electrode 110 and the second electrode 120 directly contact the electrolyte, while in other embodiments the first electrode 110 and the second electrode 120 indirectly contact the electrolyte (e.g., by way of the first binder 116 and/or the second binder 126).

According to the present embodiment, the first electrode 110 and the second electrode 120 of the secondary battery 10 include (e.g., are formed of) the first electrode wires 112 and the second electrode wires 122 respectively having the first active material layers 114 and the second active material layers 124 formed thereon. Thus, when the secondary battery 10 is bent, each of the first and second electrode wires 112 and 122 is bent so that an internal stress in a bent area may be relieved (or reduced). For example, the first electrode 110, the first electrode wires 112, the second electrode 120 and the second electrode wires 122 may be configured to bend. Also, because the first electrode 110 and the second electrode 120 are bent (e.g., are configured to bend), it is possible to prevent the secondary battery 10 from being damaged (or reduce an amount or likelihood of such damage), and it is also possible to vary a shape of the secondary battery 10 according to a shape of an electronic device.

In the embodiment of FIGS. 1 and 2, the first electrode wires 112, the separator 102, and the second electrode wires 122 are formed as one layer. However, the present invention is not limited thereto. For example, the second electrode wires 122, the separator 102, the first electrode wires 112, the separator 102, the second electrode wires 122, the separator 102, and the first electrode wires 112 may be sequentially stacked to form a secondary battery.

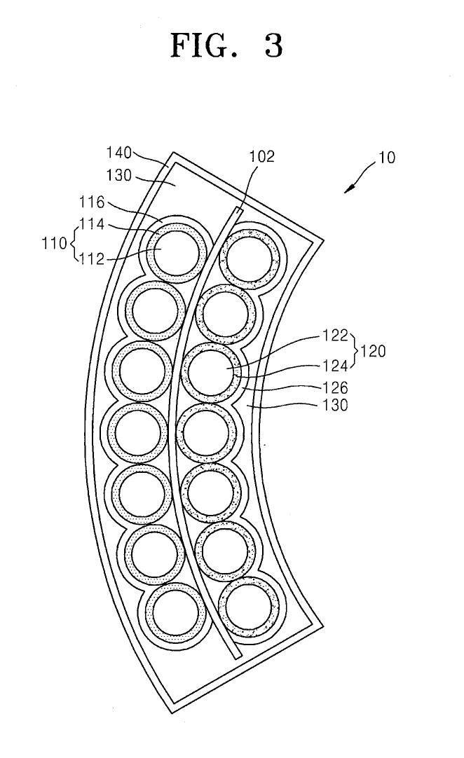

FIG. 3 is a cross-sectional view of the secondary battery 10 according to the embodiment of the present invention shown in FIGS. 1 and 2.

Referring to FIG. 3, because the first electrode 110 and the second electrode 120 of the secondary battery 10 include the first electrode wires 112 and the second electrode wires 122, respectively, when an external force is applied to the secondary battery 10, the first and second electrode wires 112 and 122 may be independently flexible (e.g., may independently flex) depending on the external force.

Therefore, although the secondary battery 10 is bent, a force that is applied to the secondary battery 10 may be distributed to each of the first and second electrode wires 112 and 122, so that it is possible to prevent an occurrence of a crease or a wrinkle at or on the first electrode 110 and the second electrode 120 (or reduce an amount or likelihood of such a crease or a wrinkle), and to improve reliability of the secondary battery 10.

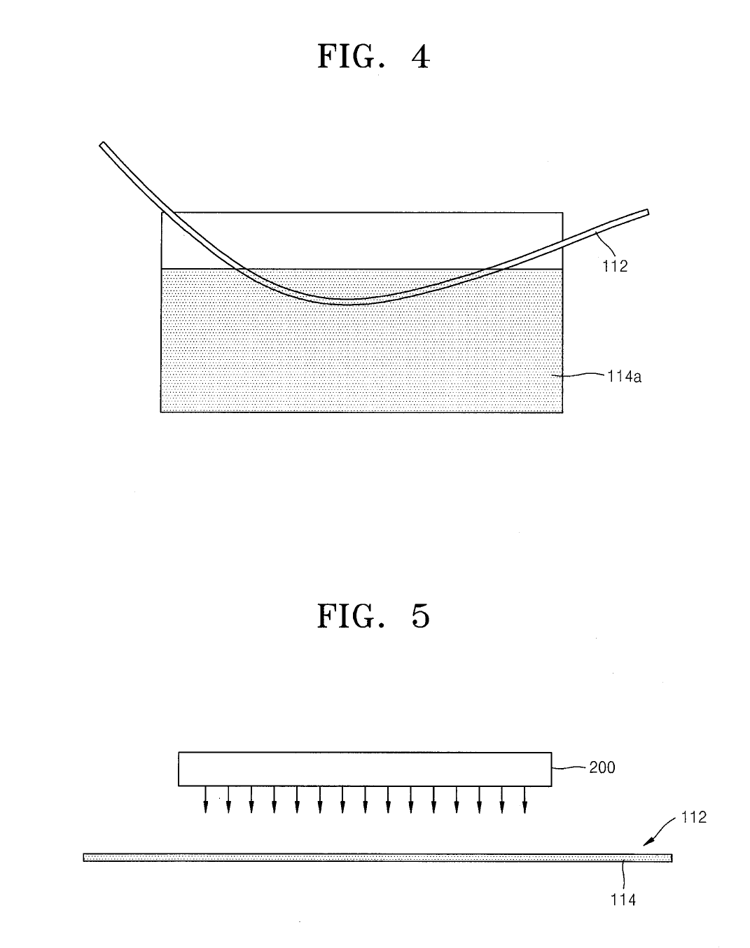

FIGS. 4 through 11 illustrate processes of a method of manufacturing the secondary battery 10 according to an embodiment of the present invention.

Referring to FIG. 4, the first electrode wire 112 is coated with a first active material 114a by using a dipping method. However, the method of forming the first active material is not limited thereto. For example, an outer circumferential surface of the first electrode wire 112 may be coated with the first active material 114a using a spray coating method, a spin coating method, a roll coating method, a die coating method, a roll coat method, a gravure printing method, or a bar coat method, but the method of forming the first active material is not limited thereto.

The first electrode wire 112 may include (e.g., may be formed of) a material having high conductivity. The material is not limited and may be any suitably conductive material, provided that the material does not cause a chemical change to a component of the secondary battery. For example, the first electrode wire 112 may include (e.g., may be formed of) aluminum, nickel, titanium, baked carbon, or the like, but the material is not limited thereto.

The first active material 114a may be a positive active material. The positive active material may include a lithium-based transition metal oxide such as LiCoO₂, LiNiO₂, LiMnO₂, or LiMnO₄, or a lithium chalcogenide-based compound, but the positive active material is not limited thereto.

Referring to FIGS. 4 and 5, the first active material 114a is dried by using a heater 200, so that the first electrode wire 112 having the first active material layer 114 on (e.g., formed on) its outer circumferential surface is formed.

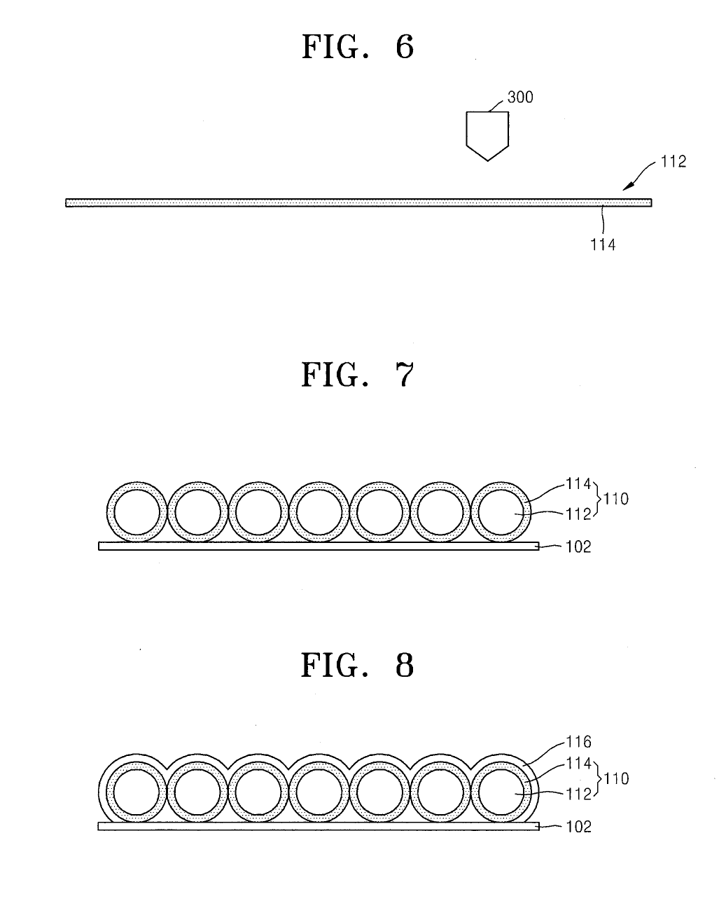

Referring to FIG. 6, a cutting process is performed by using a cutter 300 so as to allow the first electrode wire 112 to have a predetermined (or set) length. The length of the first electrode wire 112 may vary according to a length and utilization of the secondary battery 10.

Referring to FIGS. 6 and 7, a plurality of the cut first electrode wires 112 are arranged on the separator 102, so that the first electrode 110 including the first electrode wires 112 is formed.

The separator 102 may be formed by coating a PVDF-HFP co-polymer on a base material including polyethylene (PE), polystyrene (PS), polypropylene, or a co-polymer of PE and polypropylene, but the separator is not limited thereto.

Referring to FIG. 8, in order to interconnect the first electrode wires 112 having the first active material layers 114 formed thereon, and to fix the first electrode wires 112 to the separator 102, the first binder 116 is formed on the first electrode wires 112 and the separator 102.

The first binder 116 may include PVDF, HFP, or a mixture or copolymer thereof, but the first binder is not limited thereto.

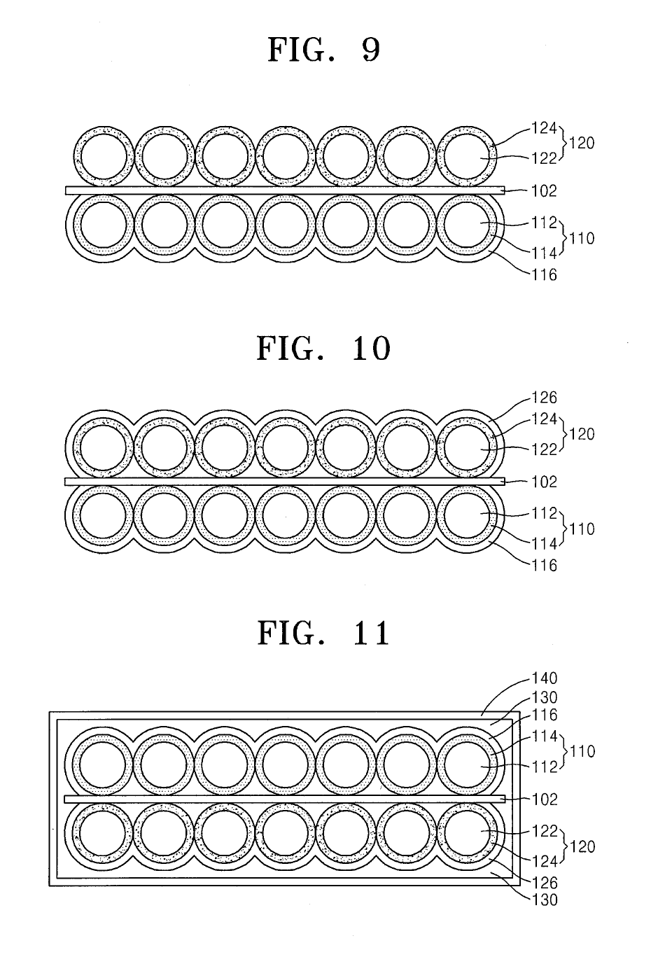

Referring to FIG. 9, the second electrode wires 122 having the second active material layers 124 on (e.g., formed on) their outer circumferential surfaces are arranged on the separator 102, so that the second electrode 120 including the second electrode wires 122 is formed.

The second electrode wires 122 having the second active material layers 124 on (e.g., formed on) their outer circumferential surfaces may be manufactured according to the method described with reference to FIGS. 4 through 6 and the descriptions thereof are incorporated here.

Each of the second electrode wires 122 may include (e.g., may be formed of) a conductive metal material including copper, stainless steel, aluminum, nickel, or the like, but the second electrode wires are not limited thereto.

Each of the second active material layers 124 may include (e.g., may be formed of) a second active material, and the second active material may be a negative active material. The negative active material may include a carbon material (such as crystalline carbon, amorphous carbon, a carbon composite, a carbon fiber, or the like), or lithium metal, or a lithium alloy, but the negative active material is not limited thereto.

Referring to FIG. 10, in order to interconnect the second electrode wires 122 having the second active material layers 124 formed thereon and to fix the second electrode wires 122 to the separator 102, the second binder 126 is formed on the second electrode wires 122 and the separator 102.

The second binder 126 may include PVDF, HFP, or a mixture or copolymer thereof, but the second binder is not limited thereto.

Referring to FIG. 11, the first electrode 110 and the second electrode 120 are encapsulated in the pouch 140, and the pouch 140 internally houses the first electrode 110 and the second electrode 120 together with the electrolyte 130.

According to embodiments of the present invention, the first electrode 110 and the second electrode 120 may include (e.g., may be formed by using) the first and second electrode wires 112 and 122 and, thus, the secondary battery 10 may be easily bent (e.g., the second battery 10 may be configured to bend).

Recently, various electronic devices have used a secondary battery, and designs of the electronic devices are a factor that affects a purchase of the electronic devices. For example, various techniques related to a wearable computer that uses a secondary battery as a power source, and applications of examples of the wearable computer are being developed and presented. Electronic devices such as a mobile phone, a notebook computer, or the like have been designed to have a curved figure for an ergonomic design.

Thus, a shape of the secondary battery for operating the aforementioned electronic devices may be bent or deformed so as to correspond to a shape of the electronic devices.

It will be understood that the exemplary embodiments described herein should be considered in a descriptive sense only and not for purposes of limitation. Descriptions of features or aspects within each embodiment should typically be considered as available for other similar features or aspects in other embodiments.

While certain embodiments of the present invention have been illustrated and described herein, it will be understood by those of ordinary skill in the art that various changes in form and details may be made therein without departing from the spirit and scope of the present invention as defined by the following claims, and equivalents thereof. Throughout the text and claims, use of the word “about” reflects the penumbra of variation associated with measurement, significant figures, and interchangeability, all as understood by a person having ordinary skill in the art to which this disclosure pertains. Additionally, throughout this disclosure and the accompanying claims, it is understood that even those ranges that may not use the term “about” to describe the high and low values are also implicitly modified by that term, unless otherwise specified.

What is claimed is:

1. A secondary battery comprising:
a separator comprising a surface and an other surface facing away from the surface;
a first electrode comprising a plurality of first electrode wires on the surface of the separator, each first electrode wire being adjacent to an other of the plurality of first electrode wires, and a plurality of first active material layers being on respective outer circumferential surfaces of the plurality of first electrode wires;
a second electrode comprising a plurality of second electrode wires on the other surface of the separator, each second electrode wire being adjacent to an other of the plurality of second electrode wires, and a plurality of second active material layers being on respective outer circumferential surfaces of the plurality of second electrode wires; and
a pouch configured to encapsulate the separator, the first electrode, and the second electrode.

2. The secondary battery of claim 1, wherein each of the plurality of first electrode wires and each of the plurality of second electrode wires has a round cross-section.

3. The secondary battery of claim 1, wherein the first electrode and the second electrode are parallel to one another and separated from each other by the separator.

4. The secondary battery of claim 1, wherein the first electrode wires have respective heights from the surface of the separator that are equal to each other.

5. The secondary battery of claim 1, wherein the second electrode wires have respective heights from the other surface of the separator that are equal to each other.

6. The secondary battery of claim 1, wherein the pouch houses an electrolyte, and the first electrode and the second electrode are coupled to each other through the electrolyte.

7. The secondary battery of claim 1, further comprising:
a first binder covering the plurality of first active material layers and a portion of the surface of the separator; and
a second binder covering the plurality of second active material layers and a portion of the other surface of the separator.

8. The secondary battery of claim 7, wherein each of the first binder and the second binder comprises polyvinylidene fluoride (PVDF), hexafluoropropylene (HFP), or a mixture or copolymer thereof.

9. The secondary battery of claim 1, wherein the secondary battery is flexible.

10. A secondary battery comprising:
a first electrode comprising a plurality of first electrode wires in a single row on a surface of a separator and a plurality of first active material layers on respective outer circumferential surfaces of the plurality of first electrode wires;
a second electrode comprising a plurality of second electrode wires in a single row on an other surface of the separator and a plurality of second active material layers on respective outer circumferential surfaces of the plurality of second electrode wires; and
a pouch configured to encapsulate the first electrode and the second electrode.

11. The secondary battery of claim 10, wherein the plurality of first electrode wires are configured to allow the plurality of first active material layers to contact each other.

12. The secondary battery of claim 10, wherein the plurality of second electrode wires are configured to allow the plurality of second active material layers to contact each other.

13. The secondary battery of claim 10, wherein the plurality of first electrode wires have respective heights from the surface of the separator that are equal to each other, and the plurality of second electrode wires have respective heights from the other surface of the separator that are equal to each other.

14. The secondary battery of claim 10, further comprising:
a first binder covering the plurality of first active material layers and a portion of the surface of the separator; and
a second binder covering the plurality of second active material layers and a portion of the other surface of the separator.

15. The secondary battery of claim 14, wherein each of the first binder and the second binder comprises polyvinylidene fluoride (PVDF), hexafluoropropylene (HFP), or a mixture or copolymer thereof.

16. The secondary battery of claim 10, wherein each of the plurality of first electrode wires and each of the plurality of second electrode wires has a round cross-section.

17. A method of manufacturing a secondary battery, the method comprising:
forming a first electrode by arranging a plurality of first electrode wires in a single row on a surface of a separator and forming a plurality of first active material layers on respective outer circumferential surfaces of the plurality of first electrode wires;
forming a second electrode by arranging a plurality of second electrode wires in a single row on an other surface of the separator and forming a plurality of second active material layers on respective outer circumferential surfaces of the plurality of second electrode wires;
housing the separator, the first electrode, and the second electrode in a pouch; and
injecting an electrolyte into the pouch.

18. The method of claim 17, wherein the forming of the first electrode further comprises forming a first binder on the plurality of first active material layers and a portion of the surface of the separator after arranging the plurality of first electrode wires in the single row on the surface of the separator.

19. The method of claim 17, wherein the forming of the second electrode further comprises forming a second binder on the plurality of second active material layers and a portion of the other surface of the separator, after arranging the plurality of second electrode wires in the single row on the other surface of the separator.

20. The method of claim 17, wherein the plurality of first electrode wires are arranged to have respective heights from the surface of the separator that are equal to each other, and the plurality of second electrode wires are arranged to have respective heights from the other surface of the separator that are equal to each other.
